(19) United States
(12) Patent Application Publication
(10) Pub. No.: US 2025/0269241 A1
(43) Pub. Date: Aug. 28, 2025

(54) GOLF BALL

(71) Applicant: Sumitomo Rubber Industries, Ltd., Kobe-shi (JP)

(72) Inventors: Takumi Kaneko, Kobe-shi (JP); Takehiko Hyodo, Kobe-shi (JP); Hiroaki Tanaka, Kobe-shi (JP)

(73) Assignee: Sumitomo Rubber Industries, Ltd., Kobe-shi (JP)

(21) Appl. No.: 19/055,716

(22) Filed: Feb. 18, 2025

(30) Foreign Application Priority Data
Feb. 28, 2024 (JP) 2024-028350

(51) Int. Cl. A63B 37/00; C08L 7/00; C08L 9/00

(52) U.S. Cl. CPC A63B 37/0073; A63B 37/00621; A63B 37/00622; A63B 37/0063; C08L 7/00; C08L 9/00; C08L 2205/025; C08L 2205/03; C08L 2312/00; C08L 2314/08

(57) ABSTRACT

An object of the present disclosure is to provide a golf ball having excellent impact durability and excellent flight distance performance. The present disclosure provides a golf ball comprising a constituent member, wherein at least one part of the constituent member is formed of a cured product of a rubber composition containing (a) a base rubber, (b) a co-crosslinking agent and (c) a crosslinking initiator, (a) the base rubber includes (a1) a polybutadiene synthesized by using a cobalt-based catalyst and (a2) a natural rubber, (b) the co-crosslinking agent includes an unsaturated carboxylic acid and/or a metal salt thereof, and (c) the crosslinking initiator includes an organic peroxide.

### FIELD OF THE DISCLOSURE

The present disclosure relates to a golf ball.

### DESCRIPTION OF THE RELATED ART

Generally, a golf ball is used repeatedly. Thus, the golf ball is required to have durability to impact. As a method for improving the impact durability of the golf ball, a method of blending a specific natural rubber in a rubber composition has been proposed.

For example, JP S61-71069 A discloses a range golf ball, obtained from a composition containing 100 parts by weight of a base rubber, 3 to 35 parts by weight of a 10 to 60 mole % epoxidized natural rubber, 20 to 35 parts by weight of methacrylic acid, and 20 to 50 parts by weight of zinc oxide.

In addition, since the golf ball is required to have flight distance performance, for example, a golf ball comprising a core having enhanced resilience has been proposed. For example, JP 2004-180716 A and JP 2004-180720 A disclose that a polybutadiene is used as a base rubber of a rubber composition for forming a constituent element of a golf ball, wherein the polybutadiene has a cis-1,4-bond in an amount of 60 weight % or more and a Mooney viscosity (ML₁₊₄ (100° C.)) of 50 or more and 120 or less, and is synthesized by using a VIII group catalyst and/or a rare earth element-based catalyst.

### SUMMARY OF THE DISCLOSURE

There is a problem that if a natural rubber is contained in the rubber composition for forming the golf ball, the flight distance performance of the golf ball tends to be lowered, although the impact durability of the golf ball is enhanced.

The present disclosure has been made in view of the above circumstances, and an object of the present disclosure is to provide a golf ball having excellent impact durability and excellent flight distance performance.

The present invention that has solved the above problem provides a golf ball comprising a constituent member, wherein at least one part of the constituent member is formed of a cured product of a rubber composition containing (a) a base rubber, (b) a co-crosslinking agent and (c) a crosslinking initiator, (a) the base rubber includes (a1) a polybutadiene synthesized by using a cobalt-based catalyst and (a2) a natural rubber, (b) the co-crosslinking agent includes an unsaturated carboxylic acid and/or a metal salt thereof, and (c) the crosslinking initiator includes an organic peroxide.

If (a2) the natural rubber is contained as the base rubber of the rubber composition for forming the constituent member of the golf ball, the impact durability of the golf ball can be enhanced. In addition, although the flight distance performance tends to be lowered if (a2) the natural rubber is contained, blending (a1) the polybutadiene synthesized by using the cobalt-based catalyst in the base rubber prevents the flight distance performance from lowering.

According to the present disclosure, a golf ball having excellent impact durability and excellent flight distance performance is obtained.

### BRIEF DESCRIPTION OF THE DRAWINGS

FIG. 1 is a partially cutaway cross-sectional view of a one-piece golf ball according to one embodiment of the present disclosure; and

FIG. 2 is a partially cutaway cross-sectional view of a multi-piece golf ball according to one embodiment of the present disclosure.

### DESCRIPTION OF THE PREFERRED EMBODIMENT

The present invention provides a golf ball comprising a constituent member, wherein at least one part of the constituent member is formed of a cured product of a rubber composition containing (a) a base rubber, (b) a co-crosslinking agent and (c) a crosslinking initiator, (a) the base rubber includes (a1) a polybutadiene synthesized by using a cobalt-based catalyst and (a2) a natural rubber, (b) the co-crosslinking agent includes an unsaturated carboxylic acid and/or a metal salt thereof, and (c) the crosslinking initiator includes an organic peroxide.

If (a2) the natural rubber is contained as the base rubber of the rubber composition for forming the constituent member of the golf ball, the impact durability of the golf ball can be enhanced. In addition, although the flight distance performance tends to be lowered if (a2) the natural rubber is contained, blending (a1) the polybutadiene synthesized by using the cobalt-based catalyst in the base rubber prevents the flight distance performance from lowering. Thus, the golf ball according to the present disclosure is a golf ball having excellent impact durability and excellent flight distance performance.

### (a) Base Rubber

(a) The base rubber includes (a1) the polybutadiene synthesized by using the cobalt-based catalyst and (a2) the natural rubber.

### (a1) Polybutadiene Synthesized by Using a Cobalt-Based Catalyst

(a1) The polybutadiene synthesized by using the cobalt-based catalyst can be obtained by polymerizing 1,3-butadiene in the presence of the cobalt-based catalyst. (a1) The polybutadiene synthesized by using the cobalt-based catalyst may be used solely, or at least two of them may be used in combination.

Examples of the cobalt-based catalyst include a cobalt salt such as cobalt chloride, cobalt bromide, cobalt nitrate, cobalt octoate (ethylhexanoate), cobalt naphthenate, cobalt acetate, and cobalt malonate; and an organic base complex or ethylalcohol complex such as cobalt bisacetylacetonate, cobalt trisacetylacetonate, cobalt ethyl acetoacetate, a pyridine complex of the cobalt salt, and a picoline complex of the cobalt salt.

The polymerization method of the butadiene is not particularly limited, and a bulk polymerization method in which the monomer is polymerized while using the conjugated diene compound monomer such as 1,3-butadiene as a polymerization solvent; a solution polymerization method in which the monomer is polymerized in a state of being dissolved in a solvent; or the like can be applied.

The amount of the cis-1,4 structure in (a1) the polybutadiene synthesized by using the cobalt-based catalyst is preferably 90 mass % or more, more preferably 93 mass % or more, and even more preferably 96 mass % or more, and is preferably 99 mass % or less, more preferably 98.5 mass % or less, and even more preferably 98 mass % or less. If the amount of the cis-1,4 structure is 90 mass % or more, the cured product of the rubber composition has further enhanced resilience, and if the amount of the cis-1,4 structure is 99 mass % or less, the rubber composition has better processibility.

The amount of the trans-1,4 structure in (a1) the polybutadiene synthesized by using the cobalt-based catalyst is preferably 0.1 mass % or more, more preferably 0.3 mass % or more, and even more preferably 0.5 mass % or more, and is preferably 10 mass % or less, more preferably 7 mass % or less, and even more preferably 3 mass % or less. If the amount of the trans-1,4 structure is 0.1 mass % or more, the rubber composition has better processibility, and if the amount of the trans-1,4 structure is 10 mass % or less, the cured product of the rubber composition has further enhanced resilience.

The amount of the 1,2-vinyl structure in (a1) the polybutadiene synthesized by using the cobalt-based catalyst is preferably 0.1 mass % or more, more preferably 0.3 mass % or more, and even more preferably 0.5 mass % or more, and is preferably 10 mass % or less, more preferably 7 mass % or less, and even more preferably 3 mass % or less. If the amount of the 1,2-vinyl structure is 0.1 mass % or more, the rubber composition has better processibility, and if the amount of the 1,2-vinyl structure is 10 mass % or less, the cured product of the rubber composition has further enhanced resilience.

The Mooney viscosity (ML₁₊₄ (100° C.)) of (a1) the polybutadiene synthesized by using the cobalt-based catalyst is preferably 20 or more, more preferably 25 or more, and even more preferably 30 or more, and is preferably 70 or less, more preferably 65 or less, and even more preferably 60 or less. If the Mooney viscosity (ML₁₊₄ (100° C.)) of (a1) the polybutadiene synthesized by using the cobalt-based catalyst falls within the above range, the rubber composition has better processibility.

It is noted that the Mooney viscosity (ML₁₊₄ (100° C.)) in the present disclosure is a value measured according to JIS K6300 (2013) using an L rotor under the conditions of preheating time: 1 minute, rotor rotation time: 4 minutes, and temperature: 100° C.

The viscosity of the toluene solution containing (a1) the polybutadiene synthesized by using the cobalt-based catalyst in a concentration of 5 mass % (25° C.) is preferably 50 cps or more, more preferably 60 cps or more, and even more preferably 70 cps or more, and is preferably 160 cps or less, more preferably 140 cps or less, and even more preferably 120 cps or less. If the viscosity of the toluene solution containing (a1) the polybutadiene synthesized by using the cobalt-based catalyst in the concentration of 5 mass % (25° C.) falls within the above range, the rubber composition has better processibility.

The viscosity of the toluene solution containing (a1) the polybutadiene synthesized by using the cobalt-based catalyst in the concentration of 5 mass % (25° C.) is a value obtained by dissolving 2.28 g of the polybutadiene in 50 ml of toluene and measuring the viscosity of the obtained toluene solution with a Cannon-Fenske viscometer No. 400 at a temperature of 25° C. It is noted that a standard solution for viscometer calibration (JIS Z8809) is used as the standard solution.

The amount of (a1) the polybutadiene synthesized by using the cobalt-based catalyst is preferably 35 mass % or more, more preferably 38 mass % or more, and even more preferably 40 mass % or more, and is preferably 75 mass % or less, more preferably 73 mass % or less, and even more preferably 70 mass % or less in 100 mass % of (a) the base rubber. If the amount falls within the above range, the cured product of the rubber composition has further enhanced resilience, and the impact durability is also further enhanced.

### (a2) Natural Rubber

(a2) The natural rubber is prepared by cutting plants that produce natural rubber latex, collecting the latex, and coagulating the rubber component contained in the latex. (a2) The natural rubber may be used solely, or at least two of them may be used in combination.

Examples of the plants that produce the natural rubber latex include Para rubber tree and Ceara rubber tree which belong to the Euphorbiaceae family; Indian rubber tree, Panama rubber tree and Lagos rubber tree which belong to the Moraceae family; Arabia rubber tree and Tragacanth rubber tree which belong to the Fabaceae family; Jelutong tree, Zanzibar rubber tree, Funtumia elastica and Urceola which belong to the Apocynaceae family; Guayule rubber tree and Rubber dandelion which belong to the Composite family; Gutta-percha tree, Balata rubber tree and Sapodilla which belong to the Sapotaceae family; Ipomoea nil which belongs to the Asclepiadaceae family; and Eucommia which belongs to the Eucommiaceae family.

Examples of (a2) the natural rubber include a CV grade where a rubber viscosity is stabilized by adding a viscosity modifier or the like to the raw latex, and a non-CV grade where a rubber viscosity is not stabilized. These natural rubbers may be used solely, or at least two of them may be used in combination. Among them, the CV grade having the stabilized viscosity is particularly preferable. It is noted that the natural rubber may be any one of STR (Standard Thailand Rubber), SMR (Standard Malaysian Rubber) and SVR (Standard Vietnam Rubber).

(a2) The natural rubber is a cis-1,4-polyisoprene, and each of a sheet rubber and a block rubber can be used. In addition, the natural rubber also includes a modified natural rubber obtained by modifying the natural rubber, such as an epoxidized natural rubber, a methacrylic acid-modified natural rubber, a halogen-modified natural rubber, a deproteinized natural rubber, a maleic acid-modified natural rubber, a sulfonic acid-modified natural rubber, and a styrene-modified natural rubber. Among them, the natural rubber preferably does not contain the epoxidized natural rubber.

As (a2) the natural rubber, Technical Specified Rubbers (TSR), and Ribbed Smoked Sheet (RSS) are preferable. In addition, the natural rubber may contain a viscosity stabilizer.

The Mooney viscosity (ML₁₊₄ (100° C.)) of (a2) the natural rubber is preferably 30 or more, more preferably 35 or more, and even more preferably 40 or more, and is preferably 90 or less, more preferably 80 or less, and even more preferably 75 or less.

If the Mooney viscosity (ML₁₊₄ (100° C.)) of (a2) the natural rubber falls within the above range, the rubber composition has better processibility.

The amount of (a2) the natural rubber is preferably 15 mass % or more, more preferably 18 mass % or more, and even more preferably 20 mass % or more, and is preferably 55 mass % or less, more preferably 53 mass % or less, and even more preferably 50 mass % or less in 100 mass % of (a) the base rubber. If the amount is 15 mass % or more, the cured product of the rubber composition has further enhanced impact durability, and if the amount is 55 mass % or less, the golf ball travels a greater flight distance.

The mass ratio ((a1)/(a2)) of (a1) the polybutadiene synthesized by using the cobalt-based catalyst to (a2) the natural rubber in (a) the base rubber is preferably 40/60 or more, more preferably 50/50 or more, and even more preferably 55/45 or more, and is preferably 80/20 or less, more preferably 75/25 or less, and even more preferably 70/30 or less. If the mass ratio ((a1)/(a2)) falls within the above range, the golf ball strikes a better balance between the flight distance performance and the impact durability.

### (Other Rubber Components)

(a) The base rubber may include another rubber component than (a1) the polybutadiene synthesized by using the cobalt-based catalyst and (a2) the natural rubber.

When (a) the base rubber includes another rubber component, the total amount of (a1) the polybutadiene synthesized by using the cobalt-based catalyst and (a2) the natural rubber is preferably 75 mass % or more, more preferably 80 mass % or more, and even more preferably 85 mass % or more in 100 mass % of (a) the base rubber.

Examples of the other rubber components include a diene-based rubber such as a polybutadiene rubber (BR) synthesized by using a catalyst other than the cobalt-based catalyst (e.g. a polybutadiene rubber synthesized by using a nickel-based catalyst, and a polybutadiene rubber synthesized by using a neodymium-based catalyst), a polyisoprene rubber (IR), a styrene-polybutadiene rubber (SBR), a chloroprene rubber (CR), a butyl rubber (IIR), and an acrylonitrile-butadiene rubber (NBR); and a non-diene-based rubber such as an ethylene-propylene rubber (EPM), an ethylene-propylene-diene rubber (EPDM), a urethane rubber, a silicone rubber, an acrylic rubber, an epichlorohydrin rubber, a polysulfide rubber, a fluororubber, and a chlorosulfonated polyethylene rubber. These rubbers may be used solely, or at least two of them may be used in combination.

### ((b) Co-Crosslinking Agent)

(b) The co-crosslinking agent has an action of crosslinking a rubber molecule by graft polymerization to a base rubber molecular chain.

The rubber composition contains an unsaturated carboxylic acid and/or a metal salt thereof as (b) the co-crosslinking agent. The unsaturated carboxylic acid and/or the metal salt thereof may be used solely, or at least two of them may be used in combination.

Examples of the unsaturated carboxylic acid include acrylic acid, methacrylic acid, fumaric acid, maleic acid and crotonic acid.

Examples of the metal ion constituting the metal salt of the unsaturated carboxylic acid include a monovalent metal ion such as sodium, potassium and lithium; a divalent metal ion such as magnesium, calcium, zinc, barium and cadmium; a trivalent metal ion such as aluminum; and other metal ions such as tin and zirconium. The above metal component may be used solely or as a mixture of at least two of them. Among them, the divalent metal ion such as magnesium, calcium, zinc, barium and cadmium is preferably used as the metal component.

As the unsaturated carboxylic acid and/or the metal salt thereof, an α,β-unsaturated carboxylic acid having 3 to 8 carbon atoms and/or a metal salt thereof is preferable. The α,β-unsaturated carboxylic acid preferably has 3 to 8 carbon atoms, more preferably has 3 to 6 carbon atoms, and even more preferably has 3 or 4 carbon atoms.

(b) The co-crosslinking agent preferably includes methacrylic acid and/or a metal salt thereof. If methacrylic acid and/or the metal salt thereof is contained as (b) the co-crosslinking agent, the golf ball has enhanced hardness and resilience performance.

The amount of (b) the co-crosslinking agent is preferably 15 parts by mass or more, more preferably 18 parts by mass or more, and even more preferably 20 parts by mass or more, and is preferably 100 parts by mass or less, more preferably 80 parts by mass or less, even more preferably 60 parts by mass or less, and particularly preferably 40 parts by mass or less, with respect to 100 parts by mass of (a) the base rubber. If the amount of (b) the co-crosslinking agent is 15 parts by mass or more, the constituent member formed from the rubber composition can be made to have an appropriate hardness with a small amount of (c) the crosslinking initiator. In addition, if the amount of (b) the co-crosslinking agent is 100 parts by mass or less, the constituent member formed from the rubber composition is not excessively hard, and thus the golf ball has better shot feeling.

### ((c) Crosslinking Initiator)

(c) The crosslinking initiator is blended to crosslink (a) the base rubber component. As (c) the crosslinking initiator, an organic peroxide is suitable. Specific examples of the organic peroxide include dicumyl peroxide, 1,1-bis(t-butylperoxy)-3,3,5-trimethylcyclohexane, 2,5-dimethyl-2,5-di(t-butylperoxy) hexane and di-t-butyl peroxide. These organic peroxides may be used solely or as a mixture of at least two of them. Among them, dicumyl peroxide is preferably used.

The amount of (c) the crosslinking initiator is preferably 0.2 part by mass or more, more preferably 0.5 part by mass or more, and even more preferably 0.7 part by mass or more, and is preferably 5.0 parts by mass or less, more preferably 4.0 parts by mass or less, and even more preferably 3.0 parts by mass or less, with respect to 100 parts by mass of (a) the base rubber. If the amount of (c) the crosslinking initiator is 0.2 part by mass or more, the crosslinked rubber product molded from the rubber composition is not excessively soft and thus the shot feeling is better, and if the amount of (c) the crosslinking initiator is 5.0 parts by mass or less, the crosslinked rubber product molded from the rubber composition has an appropriate hardness.

### ((d) Organic Sulfur Compound)

The rubber composition may further contain (d) an organic sulfur compound. If the rubber composition contains (d) the organic sulfur compound, the golf ball has further enhanced resilience performance.

Examples of (d) the organic sulfur compound include at least one member selected from the group consisting of thiophenols, thionaphthols, polysulfides, thiurams, thiocarboxylic acids, dithiocarboxylic acids, sulfenamides, dithiocarbamates, thiazoles, and their metal salts. (d) The organic sulfur compound may be used solely, or at least two of them may be used in combination. As (d) the organic sulfur compound, the organic sulfur compound having the thiol group (—SH), or the metal salt thereof is preferable, and thiophenols, thionaphthols or their metal salts are preferable.

Examples of the thiophenols include thiophenol, a thiophenol substituted with a halogen group, and metal salts thereof. Examples of the thiophenol substituted with the halogen group include thiophenols substituted with a fluoro group, such as 4-fluorothiophenol, 2,5-difluorothiophenol, 2,6-difluorothiophenol, 2,4,5-trifluorothiophenol, 2,4,5,6-tetrafluorothiophenol, and pentafluorothiophenol; thiophenols substituted with a chloro group, such as 2-chlorothiophenol, 4-chlorothiophenol, 2,4-dichlorothiophenol, 2,5-dichlorothiophenol, 2,6-dichlorothiophenol, 2,4,5-trichlorothiophenol, 2,4,5,6-tetrachlorothiophenol, and pentachlorothiophenol; thiophenols substituted with a bromo group, such as 4-bromothiophenol, 2,5-dibromothiophenol, 2,6-dibromothiophenol, 2,4,5-tribromothiophenol, 2,4,5,6-tetrabromothiophenol, and pentabromothiophenol; thiophenols substituted with an iodo group, such as 4-iodothiophenol, 2,5-diiodothiophenol, 2,6-diiodothiophenol, 2,4,5-triiodothiophenol, 2,4,5,6-tetraiodothiophenol, and pentaiodothiophenol; and metal salts thereof. As the metal salt, a zinc salt is preferable.

Examples of the thionaphthols (naphthalene thiols) include 2-thionaphthol, 1-thionaphthol, 1-chloro-2-thionaphthol, 2-chloro-1-thionaphthol, 1-bromo-2-thionaphthol, 2-bromo-1-thionaphthol, 1-fluoro-2-thionaphthol, 2-fluoro-1-thionaphthol, 1-cyano-2-thionaphthol, 2-cyano-1-thionaphthol, 1-acetyl-2-thionaphthol, 2-acetyl-1-thionaphthol, and metal salts thereof, and 2-thionaphthol, 1-thionaphthol, or the metal salt thereof is preferable. As the metal salt, a divalent metal salt is preferable, a zinc salt is more preferable. Specific examples of the metal salt include zinc salt of 1-thionaphthol, and zinc salt of 2-thionaphthol.

The polysulfides are organic sulfur compounds having a polysulfide bond, and examples thereof include disulfides, trisulfides, and tetrasulfides. As the polysulfides, diphenyl polysulfides are preferable.

Examples of the diphenyl polysulfides include diphenyl disulfide; diphenyl disulfides substituted with a halogen group, such as bis(4-fluorophenyl) disulfide, bis(2,5-difluorophenyl) disulfide, bis(2,6-difluorophenyl) disulfide, bis(2,4,5-trifluorophenyl) disulfide, bis(2,4,5,6-tetrafluorophenyl) disulfide, bis(pentafluorophenyl) disulfide, bis(4-chlorophenyl) disulfide, bis(2,5-dichlorophenyl) disulfide, bis(2,6-dichlorophenyl) disulfide, bis(2,4,5-trichlorophenyl) disulfide, bis(2,4,5,6-tetrachlorophenyl) disulfide, bis(pentachlorophenyl) disulfide, bis(4-bromophenyl) disulfide, bis(2,5-dibromophenyl) disulfide, bis(2,6-dibromophenyl) disulfide, bis(2,4,5-tribromophenyl) disulfide, bis(2,4,5,6-tetrabromophenyl) disulfide, bis(pentabromophenyl) disulfide, bis(4-iodophenyl) disulfide, bis(2,5-diiodophenyl) disulfide, bis(2,6-diodophenyl) disulfide, bis(2,4,5-triiodophenyl) disulfide, bis(2,4,5,6-tetraiodophenyl) disulfide, and bis(pentaiodophenyl) disulfide; and diphenyl disulfides substituted with an alkyl group, such as bis(4-methylphenyl) disulfide, bis(2,4,5-trimethylphenyl) disulfide, bis(pentamethylphenyl) disulfide, bis(4-t-butylphenyl) disulfide, bis(2,4,5-tri-t-butylphenyl) disulfide, and bis(penta-t-butylphenyl) disulfide.

Examples of the thiurams include thiuram monosulfides such as tetramethylthiuram monosulfide, thiuram disulfides such as tetramethylthiuram disulfide, tetraethylthiuram disulfide, and tetrabutylthiuram disulfide, and thiuram tetrasulfides such as dipentamethylenethiuram tetrasulfide. Examples of the thiocarboxylic acids include naphthalene thiocarboxylic acid. Examples of the dithiocarboxylic acids include naphthalene dithiocarboxylic acid. Examples of the sulfenamides include N-cyclohexyl-2-benzothiazole sulfenamide, N-oxydiethylene-2-benzothiazole sulfenamide, and N-t-butyl-2-benzothiazole sulfenamide.

Examples of the thiazoles include 2-mercaptobenzothiazole, a metal salt thereof, and 2-(4-morpholinodithio) benzothiazole. Examples of the metal salt of 2-mercaptobenzothiazole include a zinc salt of 2-mercaptobenzothiazole, and a cyclohexylamine salt of 2-mercaptobenzothiazole.

As (d) the organic sulfur compound, the thiophenols and/or the metal salt thereof, the thionaphthols and/or the metal salt thereof, the diphenyl disulfides, the thiuram disulfides, and the thiazoles and/or the metal salt thereof are preferable, 2,4-dichlorothiophenol, 2,6-difluorothiophenol, 2,6-2,6-dichlorothiophenol, 2,4,5-trichlorothiophenol, dibromothiophenol, 2,6-diiodothiophenol, pentachlorothiophenol, 2-mercaptobenzothiazole, and metal salts thereof are more preferable.

The amount of (d) the organic sulfur compound in the rubber composition is preferably 0.01 part by mass or more, more preferably 0.1 part by mass or more, and even more preferably 0.2 part by mass or more, and is preferably 20 parts by mass or less, more preferably 15 parts by mass or less, even more preferably 10 parts by mass or less, and particularly preferably 5 parts by mass or less, with respect to 100 parts by mass of (a) the base rubber. If the amount of (d) the organic sulfur compound is 0.01 part by mass or more, the resilience is further enhanced, and if the amount of (d) the organic sulfur compound is 20 parts by mass or less, the golf ball has better hardness.

### ((e) Metal Compound)

The rubber composition may further contain (e) a metal compound. If (e) the metal compound is contained, a metal crosslinking can be formed between the unsaturated carboxylic acids used as (b) the co-crosslinking agent.

(e) The metal compound is not particularly limited, as long as it can neutralize the unsaturated carboxylic acid in the rubber composition. Examples of (e) the metal compound include a metal hydroxide such as magnesium hydroxide, zinc hydroxide, calcium hydroxide, sodium hydroxide, lithium hydroxide, potassium hydroxide, and copper hydroxide; a metal oxide (excluding titanium oxide) such as magnesium oxide, calcium oxide, zinc oxide, and copper oxide; and a metal carbonate such as magnesium carbonate, zinc carbonate, sodium carbonate, lithium carbonate, and potassium carbonate. As (e) the metal compound, the divalent metal compound is preferable, the zinc compound is more preferable. This is because the divalent metal compound reacts with the unsaturated carboxylic acid to form a metal crosslinking. In addition, if the zinc compound is used, the golf ball has better hardness. (e) The metal compound may be used solely, or at least two of them may be used in combination.

The amount of (e) the metal compound is preferably 5 parts by mass or more, more preferably 10 parts by mass or more, and even more preferably 20 parts by mass or more, and is preferably 100 parts by mass or less, more preferably 90 parts by mass or less, even more preferably 80 parts by mass or less, particularly preferably 70 parts by mass or less, and most preferably 30 parts by mass or less, with respect to 100 parts by mass of (b) the co-crosslinking agent. If the amount of (e) the metal compound falls within the above range, the golf ball has a suitable weight.

### (Other Components)

The rubber composition may further contain an additive such as a pigment, a filler for adjusting weight or the like, an antioxidant, a peptizing agent, a softener, and a carboxylic acid, where necessary. In addition, the rubber composition may contain a rubber powder obtained by pulverizing a golf ball core or offcuts produced when preparing a core.

Examples of the pigment blended in the rubber composition include a white pigment, a blue pigment, and a purple pigment. As the white pigment, titanium oxide is preferably used. The type of titanium oxide is not particularly limited, but rutile type is preferably used because of the high opacity. In addition, the amount of titanium oxide is preferably 0.5 part by mass or more, more preferably 0.7 part by mass or more, and even more preferably 0.9 part by mass or more, and is preferably 8 parts by mass or less, more preferably 6 parts by mass or less, and even more preferably 4 parts by mass or less, with respect to 100 parts by mass of (a) the base rubber.

It is also preferred that the rubber composition contains both a white pigment and a blue pigment. The blue pigment is blended in order to cause white color to be vivid, and examples thereof include ultramarine blue, cobalt blue, and phthalocyanine blue. In addition, examples of the purple pigment include anthraquinone violet, dioxazine violet, and methyl violet.

The filler blended in the rubber composition is used as a weight adjusting agent for adjusting the weight of the obtained crosslinked rubber product, and may be blended where necessary. Examples of the filler include an inorganic filler such as calcium carbonate, barium sulfate, tungsten powder, and molybdenum powder.

The amount of the antioxidant is preferably 0.1 part by mass or more and is preferably 1 part by mass or less with respect to 100 parts by mass of (a) the base rubber. In addition, the amount of the peptizing agent is preferably 0.1 part by mass or more and is preferably 5 parts by mass or less with respect to 100 parts by mass of (a) the base rubber.

### [Preparation of Rubber Composition]

The rubber composition can be obtained by mixing and kneading (a) the base rubber, (b) the co-crosslinking agent, (c) the crosslinking initiator, and other optional additives or the like used where necessary. The kneading method is not particularly limited. For example, the kneading can be conducted with a conventional kneading machine such as a kneading roll, a banbury mixer and a kneader.

### (Cured Product of Rubber Composition)

The cured product of the rubber composition can be obtained by heating and molding the kneaded rubber composition in a mold. The molding temperature is preferably 120° C. or more, more preferably 150° C. or more, and is preferably 250° C. or less, more preferably 200° C. or less. In addition, the pressure when performing the molding is preferably 2.9 MPa or more, more preferably 5.0 MPa or more, and is preferably 25 MPa or less, more preferably 11.8 MPa or less. The molding time preferably ranges from 10 minutes to 60 minutes.

### [Golf Ball]

The golf ball according to the present disclosure comprises a constituent member, wherein at least one part of the constituent member is formed of the cured product of the rubber composition. Examples of the golf ball include a one-piece golf ball having a golf ball body formed of the cured product of the rubber composition; and a multi-piece golf ball comprising a spherical core and at least one cover layer covering the spherical core, wherein at least one part of the spherical core is formed of the cured product of the rubber composition.

### (One-Piece Golf Ball)

Examples of the one-piece golf ball include a one-piece golf ball consisting of a golf ball body; and a one-piece golf ball composed of a golf ball body and a paint film covering the golf ball body.

The one-piece golf ball preferably has a diameter ranging from 40 mm to 45 mm. In light of satisfying the regulation of US Golf Association (USGA), the diameter is particularly preferably 42.67 mm or more. In light of prevention of air resistance, the diameter is more preferably 44 mm or less, and particularly preferably 42.80 mm or less. In addition, the one-piece golf ball preferably has a mass of 40 g or more and 50 g or less. In light of obtaining greater inertia, the mass is more preferably 44 g or more, and particularly preferably 45.00 g or more. In light of satisfying the regulation of USGA, the mass is particularly preferably 45.93 g or less.

When the one-piece golf ball has a diameter in the range from 40 mm to 45 mm, the compression deformation amount (shrinking amount along the compression direction) of the one-piece golf ball when applying a load from an initial load of 98 N to a final load of 1275 N to the one-piece golf ball is preferably 2.0 mm or more, more preferably 2.2 mm or more, and even more preferably 2.4 mm or more, and is preferably 6.0 mm or less, more preferably 5.5 mm or less, and even more preferably 5.0 mm or less. If the compression deformation amount falls within the above range, the golf ball has better shot feeling.

When the one-piece golf ball has a diameter in the range from 40 mm to 45 mm, the coefficient of restitution (e40) is preferably 0.500 or more, more preferably 0.520 or more, and even more preferably 0.550 or more, and is preferably 0.800 or less, more preferably 0.780 or less, and even more preferably 0.750 or less. The measuring method of the coefficient of restitution (e40) will be described later.

The center hardness (H0) of the one-piece golf ball body is preferably 60.0 or more, more preferably 62.0 or more, and even more preferably 64.0 or more, and is preferably 74.0 or less, more preferably 72.0 or less, and even more preferably 70.0 or less in Shore C hardness. If the center hardness (H0) falls within the above range, the shot feeling is better.

The surface hardness (Hs) of the one-piece golf ball body is preferably 75.0 or more, more preferably 76.0 or more, and even more preferably 77.7 or more, and is preferably 85.0 or less, more preferably 84.0 or less, and even more preferably 83.0 or less in Shore C hardness. If the surface hardness (Hs) falls within the above range, the shot feeling is better.

The hardness difference (Hs−H0) between the center hardness (H0) and the surface hardness (Hs) of the one-piece golf ball body is preferably 10.0 or more, more preferably 11.0 or more, and even more preferably 12.0 or more, and is preferably 20.0 or less, more preferably 19.0 or less, and even more preferably 18.0 or less in Shore C hardness. If the hardness difference (Hs−H0) falls within the above range, the spin rate on shots is greater, and thus the controllability on iron shots is better.

Concave portions called “dimples” are usually formed on the surface of the golf ball body of the one-piece golf ball. The total number of the dimples is preferably 200 or more and 500 or less. If the total number of the dimples is 200 or more, the dimple effect is greater, and if the total number of the dimples is 500 or less, the dimple effect is greater because the size of the respective dimple is large. The shape (shape in a plan view) of the formed dimples includes, without limitation, a circle; a polygonal shape such as a roughly triangular shape, a roughly quadrangular shape, a roughly pentagonal shape and a roughly hexagonal shape; and other irregular shape. These shapes may be employed solely, or at least two of them may be employed in combination.

The golf ball body of the one-piece golf ball can be produced by heating and molding the rubber composition in a mold. The molding temperature is preferably 120° C. or more, more preferably 140° C. or more, and even more preferably 160° C. or more, and is preferably 200° C. or less. In addition, the pressure when performing the molding preferably ranges from 5 MPa to 25 MPa. The molding time preferably ranges from 10 minutes to 60 minutes.

A paint film or a mark may be formed on the surface of the golf ball body of the one-piece golf ball. The thickness of the paint film is not particularly limited, and is preferably 5 μm or more, more preferably 6 μm or more, and even more preferably 8 μm or more, and is preferably 50 μm or less, more preferably 40 μm or less, and even more preferably 30 μm or less. If the thickness of the paint film is 5 μm or more, the paint film is hard to wear off, even if the golf ball is continuously used, and if the thickness of the paint film is 50 μm or less, the dimple effect is not reduced and thus the flight performance of the golf ball is better.

### (Multi-Piece Golf Ball)

The multi-piece golf ball is a golf ball comprising a spherical core and at least one cover layer covering the spherical core, wherein at least one part of the spherical core is formed of the cured product of the rubber composition.

The spherical core may be single-layered or multi-layered. Examples of the spherical core include a single-layered core formed of the cured product of the rubber composition; and a dual-layered core composed of an inner layer and an outer layer, wherein the inner layer and/or the outer layer is formed of the cured product of the rubber composition.

The diameter of the spherical core is preferably 34.8 mm or more, and is preferably 42.2 mm or less, more preferably 41.8 mm or less, even more preferably 41.2 mm or less, and particularly preferably 40.8 mm or less. If the diameter of the spherical core is 34.8 mm or more, the cover does not become excessively thick and thus the impact durability is better. On the other hand, if the diameter of the spherical core is 42.2 mm or less, the cover does not become excessively thin and thus functions better.

When the core has a diameter in the range from 34.8 mm to 42.2 mm, the compression deformation amount (shrinking amount along the compression direction) of the core when applying a load from an initial load of 98 N to a final load of 1275 N to the core is preferably 2.0 mm or more, more preferably 2.3 mm or more, and even more preferably 2.5 mm or more, and is preferably 5.0 mm or less, more preferably 4.5 mm or less, and even more preferably 4.3 mm or less. If the compression deformation amount falls within the above range, the shot feeling is better.

The spherical core can be produced by mixing and kneading the rubber composition, and molding the kneaded rubber composition in a mold. The molding conditions are not particularly limited, but the molding is generally carried out at a temperature ranging from 130° C. to 200° C. under a pressure ranging from 5 MPa to 25 MPa for 10 minutes to 60 minutes.

The cover of the golf ball is formed from a cover composition containing a resin component. Examples of the resin component include an ionomer resin, a thermoplastic polyurethane elastomer having a trade name of “Elastollan (registered trademark)” available from BASF Japan Ltd., a thermoplastic polyamide elastomer having a trade name of “Pebax (registered trademark)” available from Arkema K. K., a thermoplastic polyester elastomer having a trade name of “Hytrel (registered trademark)” available from Du Pont-Toray Co., Ltd., and a thermoplastic styrene elastomer having a trade name of “TEFABLOC (registered trademark)” available from Mitsubishi Chemical Corporation.

In addition to the resin component, the cover composition may further contain a pigment component such as a white pigment (e.g. titanium oxide), a blue pigment and a red pigment, a weight adjusting agent such as zinc oxide, calcium carbonate and barium sulfate, a dispersant, an antioxidant, an ultraviolet absorber, a light stabilizer, or a fluorescent material or fluorescent brightener, as long as they do not impair the performance of the cover.

Examples of the method of molding the cover include a method which comprises molding the cover composition into a hollow shell, covering the core with a plurality of the hollow shells and performing compression molding (preferably a method which comprises molding the cover composition into a hollow half-shell, covering the core with two of the half-shells and performing compression molding); and a method which comprises injection molding the cover composition directly onto the core.

The thickness of the cover is preferably 4.0 mm or less, more preferably 3.0 mm or less, and even more preferably 2.0 mm or less. If the thickness of the cover is 4.0 mm or less, the obtained golf ball has better shot feeling. The thickness of the cover is preferably 0.3 mm or more, more preferably 0.4 mm or more, and even more preferably 0.5 mm or more. If the thickness of the cover is 0.3 mm or more, the durability or wear resistance of the cover is better. In the case that the golf ball comprises a plurality of cover layers, the total thickness of the plurality of cover layers preferably falls within the above range.

Concave portions called “dimples” are usually formed on the surface of the cover when the cover is molded. The total number of the dimples formed on the cover is preferably 200 or more and 500 or less. If the total number of the dimples is 200 or more, the dimple effect is greater, and if the total number of the dimples is 500 or less, the dimple effect is greater because the size of the respective dimples is large. The shape (shape in a plan view) of the formed dimples includes, without limitation, a circle; a polygonal shape such as a roughly triangular shape, a roughly quadrangular shape, a roughly pentagonal shape and a roughly hexagonal shape; and other irregular shapes. These shapes may be employed solely, or at least two of them may be employed in combination.

The golf ball body having the cover formed thereon is ejected from the mold, and is preferably subjected to surface treatments such as deburring, cleaning and sandblast where necessary. In addition, if desired, a paint film or a mark may be formed. The thickness of the paint film is not particularly limited, and is preferably 5 μm or more, more preferably 6 μm or more, and even more preferably 8 μm or more, and is preferably 50 μm or less, more preferably 40 μm or less, and even more preferably 30 μm or less. If the thickness of the paint film is 5 μm or more, the paint film is hard to wear off, even if the golf ball is continuously used, and if the thickness of the paint film is 50 μm or less, the dimple effect is not reduced and thus the flight performance of the golf ball is better.

The multi-piece golf ball preferably has a diameter ranging from 40 mm to 45 mm. In light of satisfying the regulation of US Golf Association (USGA), the diameter is particularly preferably 42.67 mm or more. In light of prevention of air resistance, the diameter is more preferably 44 mm or less, and particularly preferably 42.80 mm or less. In addition, the multi-piece golf ball preferably has a mass of 40 g or more and 50 g or less. In light of obtaining greater inertia, the mass is more preferably 44 g or more, and particularly preferably 45.00 g or more. In light of satisfying the regulation of USGA, the mass is particularly preferably 45.93 g or less.

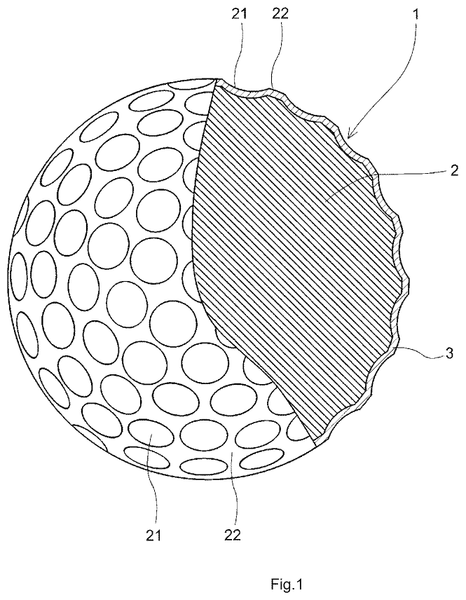

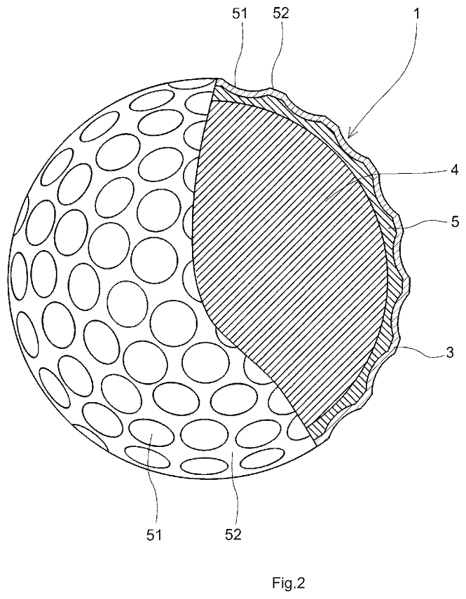

One example of the golf ball according to the present disclosure will be explained by reference to FIGS. 1 and 2. FIG. 1 is a partially cutaway cross-sectional view of a one-piece golf ball according to one embodiment of the present disclosure, and FIG. 2 is a partially cutaway cross-sectional view of a multi-piece golf ball according to one embodiment of the present disclosure.

A golf ball 1 shown in FIG. 1 is a one-piece golf ball composed of a golf ball body 2 and a paint film 3 covering the golf ball body 2. A plurality of dimples 21 are formed on the surface of the golf ball body 2. Other portions than the dimples 21 on the surface of the golf ball 1 are lands 22. The paint film 3 is formed on an outer side of the golf ball body 2 of the golf ball 1.

A golf ball 1 shown in FIG. 2 comprises a golf ball body composed of a spherical core 4 and a cover 5 covering the spherical core 4. A plurality of dimples 51 are formed on the surface of the cover 5. Other portions than the dimples 51 on the surface of the golf ball 1 are lands 52. A paint film 3 is formed on an outer side of the cover 5 of the golf ball 1.

### EXAMPLES

Next, the present disclosure will be described in detail by way of examples. However, the present disclosure is not limited to the examples described below. Various changes and modifications without departing from the spirit of the present disclosure are included in the scope of the present disclosure.

### Evaluation Method

### (1) Compression Deformation Amount (Mm)

The deformation amount along the compression direction of the golf ball (shrinking amount along the compression direction of the golf ball), when applying a load from an initial load of 98 N to a final load of 1275 N to the golf ball, was measured.

The compression deformation amount was measured with a YAMADA type compression tester “SCH”. The golf ball was placed on a metal rigid plate of the tester. A metal cylinder slowly fell toward the golf ball. The golf ball sandwiched between the bottom of the cylinder and the rigid plate deformed. The travelling distance of the cylinder when applying a load from an initial load of 98 N to a final load of 1275 N to the golf ball was measured. The travelling speed of the cylinder before applying the initial load was 0.83 mm/s. The travelling speed of the cylinder when applying the load from the initial load to the final load was 1.67 mm/s.

### (2) Coefficient of Restitution

A metal cylindrical object with a mass of 198.4 g was allowed to collide with each golf ball at a speed of 40 m/sec, and the speeds of the cylindrical object and the golf ball before and after the collision were measured. Based on the speed and mass of each object, the coefficient of restitution of each golf ball was calculated. The measurement was conducted using twelve samples for each golf ball, and the average value thereof was adopted as the coefficient of restitution for that golf ball.

### (3) Flight Distance

A W #1 driver (“XXIO (registered trademark) 12”, Shaft hardness: S, Loft angle: 10.5°, available from Sumitomo Rubber Industries, Ltd.) was installed on a swing machine available from Golf Laboratories, Inc. The hitting point was set at the face center. The golf ball was hit at a head speed of 40 m/sec, and the flight distance (the distance from the launch point to the stop point) was measured. The measurement was conducted using twelve samples for each golf ball, and the average value thereof was adopted as the flight distance for that golf ball.

### (4) Impact Durability

A W #1 driver (“XXIO (registered trademark) 12”, Shaft hardness: S, Loft angle: 10.5°, available from Sumitomo Rubber Industries, Ltd.) was installed on a swing machine available from Golf Laboratories, Inc. The golf balls were hit repeatedly at a head speed of 40 m/sec until a crack occurred, and the hitting number when the crack occurred was counted. The measurement was conducted using twelve samples for each golf ball, and the average value thereof was adopted as the hitting number for that golf ball. It is noted that the hitting number of the golf ball No. 9 was defined as 100, and the durability of each golf ball was represented by converting the hitting number of each golf ball into this index.

### [Production of One-Piece Golf Ball]

According to the formulations shown in Table 1, the rubber compositions were kneaded with a kneading roll, and heat pressed at a temperature of 170° C. for 20 minutes in upper and lower molds, each having a hemispherical cavity, to obtain the golf ball bodies having a diameter of 42.7 mm.

TABLE 1

| Golf ball No. | | 1 | 2 | 3 | 4 | 5 |
|---|---|---|---|---|---|---|
| Formulation | (a1) Polybutadiene rubber (Co) | 30 | 40 | 50 | 60 | 70 |
| (parts by | (a2) Natural rubber | 60 | 50 | 40 | 30 | 20 |
| mass) | Polybutadiene rubber (Ni) | 10 | 10 | 10 | 10 | 10 |
| | Polybutadiene rubber (Nd) | — | — | — | — | — |
| | Isoprene rubber | — | — | — | — | — |
| | Methacrylic acid | 26 | 25 | 25 | 24 | 23 |
| | Dicumyl peroxide | 2.8 | 2.3 | 1.9 | 1.6 | 1.3 |
| | Zinc pentachlorothiophenol | 0.4 | 0.4 | 0.4 | 0.4 | 0.4 |
| | Zinc oxide | 23.5 | 23.5 | 23.5 | 23.5 | 23.5 |
| | Stearic acid | 0.2 | 0.2 | 0.2 | 0.2 | 0.2 |
| | Titanium oxide | 1.0 | 1.0 | 1.0 | 1.0 | 1.0 |
| Mass ratio ((a1)/(a2)) | | 33/67 | 44/56 | 56/44 | 67/33 | 78/22 |
| Hardness | Center hardness (H0) | 67.5 | 67.0 | 66.9 | 66.0 | 65.0 |
| distribution | Surface hardness (Hs) | 83.0 | 82.0 | 81.4 | 81.0 | 80.5 |
| (Shore C) | Hardness difference (Hs − H0) | 15.5 | 15.0 | 14.6 | 15.0 | 15.5 |
| Compression deformation amount (mm) | | 2.4 | 2.4 | 2.5 | 2.5 | 2.5 |
| Coefficient of restitution | | 0.710 | 0.715 | 0.718 | 0.725 | 0.730 |
| W#1 shorts | Flight distance (yd) | 190.0 | 193.0 | 194.5 | 194.0 | 193.5 |
| | Impact durability | 150 | 300 | 427 | 300 | 200 |

| Golf ball No. | | 6 | 7 | 8 | 9 |
|---|---|---|---|---|---|
| Formulation | (a1) Polybutadiene rubber (Co) | 80 | — | 100 | — |
| (parts by | (a2) Natural rubber | 10 | 40 | — | — |
| mass) | Polybutadiene rubber (Ni) | 10 | 40 | — | 55 |
| | Polybutadiene rubber (Nd) | — | 20 | — | 35 |
| | Isoprene rubber | — | — | — | 10 |
| | Methacrylic acid | 22 | 25 | 22 | 22 |
| | Dicumyl peroxide | 1.0 | 1.9 | 0.7 | 1.9 |
| | Zinc pentachlorothiophenol | 0.4 | 0.4 | — | — |
| | Zinc oxide | 23.5 | 23.5 | 23.5 | 23.5 |
| | Stearic acid | 0.2 | 0.2 | — | — |
| | Titanium oxide | 1.0 | 1.0 | 1.0 | 1.0 |
| Mass ratio ((a1)/(a2)) | | 89/11 | — | — | — |
| Hardness | Center hardness (H0) | 64.0 | 66.2 | 63.6 | 60.1 |
| distribution | Surface hardness (Hs) | 80.0 | 77.5 | 80.2 | 80.0 |
| (Shore C) | Hardness difference (Hs − H0) | 16.0 | 11.4 | 16.6 | 19.9 |
| Compression deformation amount (mm) | | 2.4 | 2.5 | 2.4 | 2.5 |
| Coefficient of restitution | | 0.735 | 0.710 | 0.747 | 0.720 |
| W#1 shorts | Flight distance (yd) | 192.0 | 190.7 | 194.5 | 192.0 |
| | Impact durability | 100 | 712 | 90 | 100 |

Polybutadiene rubber (Co): “BR150L” (a high-cis butadiene rubber synthesized by using a cobalt-based catalyst) (amount of cis-1,4 structure = 98 mass %, amount of trans-1,4 structure = 1 mass %, amount of 1,2-vinyl structure = 1 mass %, Mooney viscosity (ML₁₊₄ (100° C.)) = 43, viscosity of a toluene solution containing the polybutadiene in a concentration of 5 mass %: 105 cps) available from UBE Elastomer Co. Ltd.
Polybutadiene rubber (Ni): “BR01” (a high-cis butadiene rubber synthesized by using a nickel-based catalyst) (amount of cis-1,4 structure = 95 mass %, Mooney viscosity (ML₁₊₄ (100° C.)) = 45) available from JSR Corporation
Polybutadiene rubber (Nd): “BR730” (a high-cis polybutadiene rubber synthesized by using a neodymium-based catalyst) (amount of cis-1,4 structure = 95 mass %, Mooney viscosity (ML₁₊₄ (100° C.)) = 55) available from JSR Corporation
Isoprene rubber: “IR2200” (Mooney viscosity (ML₁₊₄ (100° C.)) = 82) available from Zeon Corporation
Natural rubber: “STR5L” (Mooney viscosity (ML₁₊₄ (100° C.)) = 72) available from Srijaroen Rubber Co., Ltd.
Zinc oxide: “Ginrei R” available from Toho Zinc Co., Ltd.
Methacrylic acid: available from Mitsubishi Chemical Corporation
Zinc pentachlorothiophenol: (including zinc stearate in an amount of 28 mass % to 32 mass %) available from FUJIFILM Wako Chemicals Corporation
Stearic acid: available from NOF Corporation
Titanium oxide: “CR-60” available from Ishihara Sangyo Kaisha, Ltd.
Dicumyl peroxide: “Percumyl (registered trademark) D” available from NOF Corporation

The golf ball No. 1 is a case that the mass ratio ((a1)/(a2)) of (a1) the polybutadiene synthesized by using the cobalt-based catalyst to (a2) the natural rubber in (a) the base rubber is less than 40/60. The golf ball No. 1 has poor flight distance performance.

The golf balls No. 2 to 5 are cases that the mass ratio ((a1)/(a2)) of (a1) the polybutadiene synthesized by using the cobalt-based catalyst to (a2) the natural rubber in (a) the base rubber falls within the range from 40/60 to 80/20. These golf balls No. 2 to 5 have excellent impact durability and excellent flight distance performance.

The golf ball No. 6 is a case that the mass ratio ((a1)/(a2)) of (a1) the polybutadiene synthesized by using the cobalt-based catalyst to (a2) the natural rubber in (a) the base rubber is more than 80/20. The golf ball No. 6 has poor impact durability.

The golf ball No. 7 is a case that (a) the base rubber contains (a2) the natural rubber but does not contain (a1) the polybutadiene synthesized by using the cobalt-based catalyst. The golf ball No. 7 has poor flight distance performance.

The golf ball No. 8 is a case that (a) the base rubber consists of (a1) the polybutadiene synthesized by using the cobalt-based catalyst. The golf ball No. 8 has poor impact durability.

The golf ball No. 9 is a case that (a) the base rubber contains a polybutadiene synthesized by using a nickel-based catalyst, a polybutadiene synthesized by using a neodymium-based catalyst and an isoprene rubber. The golf ball No. 9 has poor impact durability.

The present disclosure (1) is a golf ball comprising a constituent member, wherein at least one part of the constituent member is formed of a cured product of a rubber composition containing (a) a base rubber, (b) a co-crosslinking agent and (c) a crosslinking initiator, (a) the base rubber includes (a1) a polybutadiene synthesized by using a cobalt-based catalyst and (a2) a natural rubber, (b) the co-crosslinking agent includes an unsaturated carboxylic acid and/or a metal salt thereof, and (c) the crosslinking initiator includes an organic peroxide.

The present disclosure (2) is the golf ball according to the present disclosure (1), wherein a mass ratio ((a1)/(a2)) of (a1) the polybutadiene synthesized by using the cobalt-based catalyst to (a2) the natural rubber in (a) the base rubber ranges from 40/60 to 80/20.

The present disclosure (3) is the golf ball according to the present disclosure (1) or (2), wherein the unsaturated carboxylic acid and/or the metal salt thereof included in (b) the co-crosslinking agent is methacrylic acid and/or a metal salt thereof.

The present disclosure (4) is the golf ball according to any one of the present disclosures (1) to (3), wherein the rubber composition further contains an organic sulfur compound.

The present disclosure (5) is the golf ball according to any one of the present disclosures (1) to (4), wherein the golf ball is a one-piece golf ball, and a golf ball body thereof is formed of the cured product of the rubber composition.

This application is based on Japanese patent application No. 2024-028350 filed on Feb. 28, 2024, the content of which is hereby incorporated by reference.

1. A golf ball comprising a constituent member, wherein at least one part of the constituent member is formed of a cured product of a rubber composition containing (a) a base rubber, (b) a co-crosslinking agent and (c) a crosslinking initiator,
(a) the base rubber includes (a1) a polybutadiene synthesized by using a cobalt-based catalyst and (a2) a natural rubber,
(b) the co-crosslinking agent includes an unsaturated carboxylic acid and/or a metal salt thereof, and
(c) the crosslinking initiator includes an organic peroxide.

2. The golf ball according to claim 1, wherein a mass ratio ((a1)/(a2)) of (a1) the polybutadiene synthesized by using the cobalt-based catalyst to (a2) the natural rubber in (a) the base rubber ranges from 40/60 to 80/20.

3. The golf ball according to claim 1, wherein the unsaturated carboxylic acid and/or the metal salt thereof included in (b) the co-crosslinking agent is methacrylic acid and/or a metal salt thereof.

4. The golf ball according to claim 1, wherein the rubber composition further contains an organic sulfur compound.

5. The golf ball according to claim 1, wherein the golf ball is a one-piece golf ball, and a golf ball body thereof is formed of the cured product of the rubber composition.

6. The golf ball according to claim 1, wherein an amount of (a1) the polybutadiene synthesized by using the cobalt-based catalyst ranges from 35 mass % to 75 mass % in 100 mass % of (a) the base rubber.

7. The golf ball according to claim 1, wherein an amount of (a2) the natural rubber ranges from 15 mass % to 55 mass % in 100 mass % of (a) the base rubber.

8. The golf ball according to claim 1, wherein (a) the base rubber further includes another rubber component than (a1) the polybutadiene synthesized by using the cobalt-based catalyst and (a2) the natural rubber, and a total amount of (a1) the polybutadiene synthesized by using the cobalt-based catalyst and (a2) the natural rubber is 75 mass % or more in 100 mass % of (a) the base rubber.

9. The golf ball according to claim 1, wherein an amount of a cis-1,4 structure in (a1) the polybutadiene synthesized by using the cobalt-based catalyst ranges from 90 mass % to 99 mass %.

10. The golf ball according to claim 1, wherein an amount of a trans-1,4 structure in (a1) the polybutadiene synthesized by using the cobalt-based catalyst ranges from 0.1 mass % to 10 mass %.

11. The golf ball according to claim 1, wherein an amount of a 1,2-vinyl structure in (a1) the polybutadiene synthesized by using the cobalt-based catalyst ranges from 0.1 mass % to 10 mass %.

12. The golf ball according to claim 1, wherein a toluene solution containing (a1) the polybutadiene synthesized by using the cobalt-based catalyst in a concentration of 5 mass % has a viscosity ranging from 50 cps to 160 cps (at 25° C.).

13. The golf ball according to claim 5, wherein the one-piece golf ball has a center hardness (H0) ranging from 60.0 to 74.0 in Shore C hardness.

14. The golf ball according to claim 5, wherein the one-piece golf ball has a surface hardness (Hs) ranging from 75.0 to 85.0 in Shore C hardness.

15. The golf ball according to claim 5, wherein the one-piece golf ball has a hardness difference (Hs−H0) ranging from 10.0 to 20.0 in Shore C hardness between a center hardness (H0) and a surface hardness (Hs) thereof.
